(19) United States
(12) Patent Application Publication
(10) Pub. No.: US 2026/0258636 A1
(43) Pub. Date: Sep. 3, 2026

(54) VARIABLE BLADE FLOAT

(71) Applicant: Deere & Company, Moline, IL (US)

(72) Inventors: Adam H. KWIATKOWSKI, Dubuque, IA (US); Joshua M. SCHAU, Dubuque, IA (US)

(21) Appl. No.: 19/066,266

(22) Filed: Feb. 28, 2025

(51) Int. Cl. E02F 9/22; E02F 3/76; E02F 3/84; E02F 9/20; E02F 9/26; F15B 1/26; F15B 13/02; F15B 19/00

(52) U.S. Cl. CPC E02F 9/2203; E02F 3/7636; E02F 3/844; E02F 9/2004; E02F 9/2037; E02F 9/2217; E02F 9/2296; E02F 9/26; F15B 1/26; F15B 13/024; F15B 13/025; F15B 19/00

(57) ABSTRACT

A work vehicle includes a work implement movable relative to a frame. A hydraulic control circuit controls movement of the work implement. The hydraulic control circuit includes a pump, a reservoir and a hydraulic actuator. A hydraulic control valve controls supply of hydraulic fluid between the pump, the actuator and the reservoir. A first PPRV is fluidly positioned between the reservoir and a first side of the hydraulic actuator. A first pressure sensor senses a pressure at the first side of the hydraulic actuator. A controller receives a set value for a first predetermined pressure value, and receives the first pressure signal. The controller is configured to send a command signal to the first PPRV to adjust the first predetermined pressure value based at least in part on the set value for the first predetermined pressure value and based at least in part on the first pressure signal.

### BACKGROUND

The present disclosure relates to a system for controlling floating pressure on a floating blade or other work implement.

### DESCRIPTION OF THE PRIOR ART

One prior system for controlling variable blade float is disclosed in U.S. Pat. No. 11,408,144, to Zell et al, and assigned to Deere & Company, the assignee of the present application. The present disclosure describes a number of further developments of systems like those disclosed in U.S. Pat. No. 11,408,144.

### SUMMARY OF THE DISCLOSURE

In U.S. Pat. No. 11,408,144, as shown in FIG. 3 thereof, a control valve 140 is located between the pump 132 and the PPRV's 142 and 146. Also, the on/off valves 144 and 146 are pilot operated valves which are operated in response to a command signal sent to the control valve 140, which then communicates hydraulic fluid to the pilot of the on/off valves 144 and 146. In the present disclosure the corresponding PPRV's are directly communicated with the pump outlet without any intervening control valve between pump and the PPRV's. And in the present disclosure the on/off valves directly receive their command signals from the controller.

Also, in U.S. Pat. No. 11,408,144 a feedback adjustment of relief settings of the PPRV's is based upon a sensed position of the hydraulic actuator. In the present disclosure a feedback adjustment of the relief settings of the PPRV's is based on sensed pressures at the hydraulic actuator.

In one embodiment, the present disclosure provides a work vehicle including a frame, an operator cab connected to the frame, and a work implement movable relative to the frame. A hydraulic control circuit is operable to control movement of the work implement. The hydraulic control circuit includes a pump and a reservoir. A hydraulic actuator includes a first side and a second side, the hydraulic actuator being configured to move the work implement relative to the frame. A hydraulic control valve is configured to control supply of hydraulic fluid from the pump to the actuator and to control return of hydraulic fluid from the actuator to the reservoir. A first proportional pressure reducing and/or relief valve (PPRV) is fluidly positioned between the reservoir and the first side of the hydraulic actuator, the first PPRV configured to permit flow of fluid from the first side of actuator to the reservoir in response to a pressure at the first side of the hydraulic actuator being greater than a first predetermined pressure value. A second PPRV is fluidly positioned between the reservoir and the second side of the hydraulic actuator. A first pressure sensor is configured to sense a pressure at the first side of the hydraulic actuator, the first pressure sensor being configured to generate a first pressure signal. A second pressure sensor is configured to sense a pressure at the second side of the hydraulic actuator, the second pressure sensor being configured to generate a second pressure signal. A controller is in electrical communication with the control valve, the first and second PPRV's, and the first and second pressure sensors. The controller is configured to receive a set value for the first predetermined pressure value, and to receive the first pressure signal from the first pressure sensor. The controller is configured to send a command signal to the first PPRV to adjust the first predetermined pressure value based at least in part on the set value for the first predetermined pressure value and based at least in part on the first pressure signal.

In another embodiment a work vehicle includes a frame, a work implement movable relative to the frame, and a hydraulic control circuit operable to control movement of the work implement. The hydraulic control circuit includes a pump, a reservoir, a hydraulic actuator, a control valve, a controller, and first and second PPRV's. The hydraulic actuator includes a first side and a second side, and the hydraulic actuator is configured to move the work implement relative to the frame. The control valve is configured to control supply of hydraulic fluid from the pump to the actuator, and to control return of hydraulic fluid from the actuator to the reservoir. The first PPRV is fluidly positioned between the reservoir and the first side of the hydraulic actuator. The first PPRV is configured to permit flow of fluid from the first side of actuator to the reservoir in response to a pressure at the first side of the hydraulic actuator being greater than a first predetermined pressure value. The first PPRV is directly communicated with the pump without any intervening control valve between the pump and the first PPRV. A second PPRV is fluidly positioned between the reservoir and the second side of the hydraulic actuator.

Other aspects of the disclosure will become apparent by consideration of the detailed description and accompanying drawings.

### BRIEF DESCRIPTION OF THE DRAWINGS

FIG. 1 is a perspective view of a work vehicle in which the disclosed hydraulic control circuit may be implemented.

FIG. 2 is another perspective view of the work vehicle of FIG. 1.

FIG. 3 is a schematic diagram of a hydraulic control circuit for a system according to some embodiments of the disclosure.

FIG. 4 is a schematic diagram of an electronic control system associated with the hydraulic control circuit of FIG. 3.

FIG. 5 is a flow diagram showing one possible design implementation of operation of the variable blade float system.

FIG. 6 is a flow diagram showing another possible design implementation of operation of the variable blade float system.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

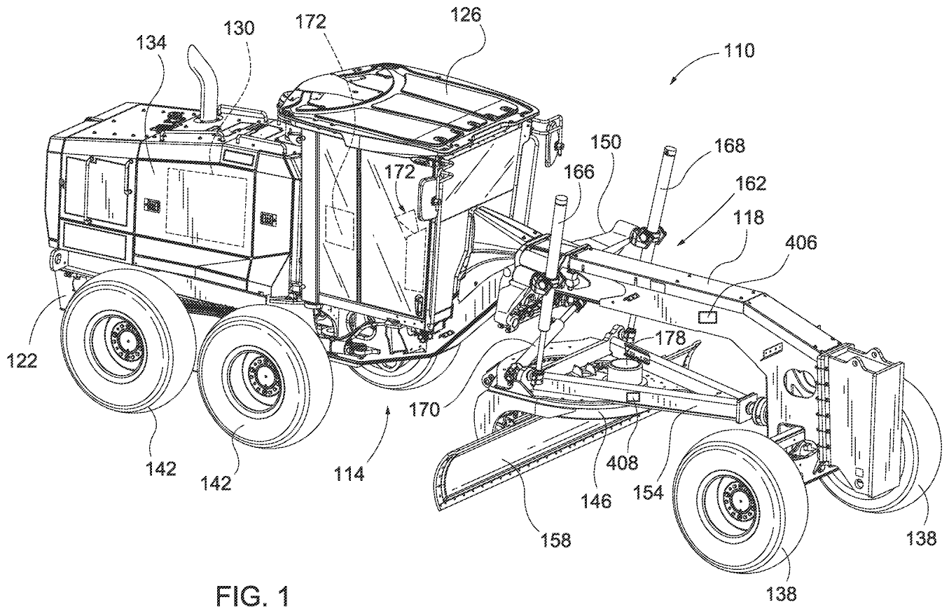

FIG. 1 illustrates a work vehicle, which is a motor grader (or simply “grader”) 110 in the illustrated embodiment. The grader 110 includes a chassis 114 with a front frame 118 and a rear frame 122. The front frame 118 supports an operator cab 126 that may include an operator seat, controls for operating the grader 110, and the like. A prime mover 130 (e.g., a diesel engine, battery electric or hybrid drive) is supported on the rear frame 122 and is enclosed within a compartment 134. The chassis 114 is supported by front wheels 138 at the front of the grader 110 and by tandem rear wheels 142 at the rear of the grader 110.

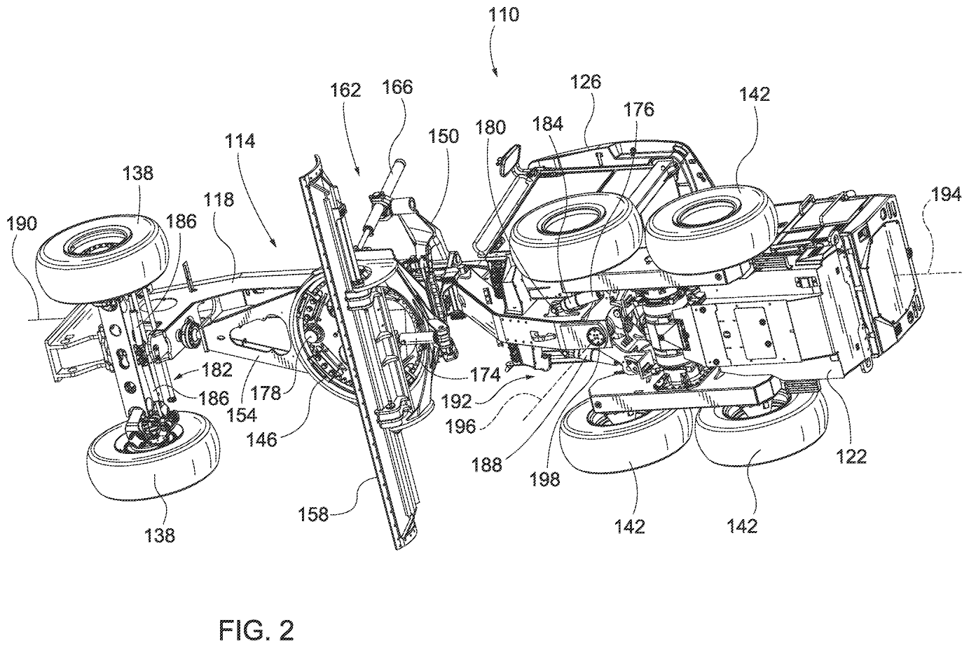

The grader 110 includes a circle 146 disposed in front of the operator cab 126 and suspended below the front frame 118 by a lifter bracket 150 and a drawbar 154. The lifter bracket 150 may also be referred to as a saddle arm 150. A work implement, which is a blade 158 or moldboard in the illustrated embodiment, extends laterally across the circle 146. The grader 110 includes a blade positioning assembly 162 that allows the position and orientation of the blade 158 to be adjusted. In the illustrated embodiment, a left lift actuator 166 and a right lift actuator 168 extend between the lifter bracket 150 and the circle 146 to tilt, raise, and lower the circle 146 and the blade 158. A shift actuator 170 is provided to shift the blade 158 laterally relative to the front frame 118, and a pitch actuator 174 (FIG. 2) is provided to vary a pitch angle of the blade 158. The blade positioning assembly 162 also includes a rotary actuator 178 to rotate the blade 158 about a vertical axis. In the illustrated embodiment, the various actuators 166, 168, 170, 174, 178 of the blade positioning assembly 162 are hydraulic actuators (e.g., single or double acting cylinders, hydraulic motors, etc.); however, in some embodiments the blade positioning assembly 162 may alternatively include one or more electric motors, pneumatic actuators, or the like in place of any of the hydraulic actuators 166, 168, 170, 174, 178.

The prime mover 130 is coupled to the rear wheels 142 via a suitable transmission (not shown) to drive the rear wheels 142 (FIG. 1). Alternatively, or additionally, the prime mover 130 may be coupled to the front wheels 138 to drive the front wheels 138. The front frame 118 supports a steering assembly 182 for steering the front wheels 138 (FIG. 2). The steering assembly 182 includes steering actuators 186, which are hydraulic actuators in the illustrated embodiment. In other embodiments, other types of actuators can be used. In addition, in some embodiments, additional steering actuators may be provided such that both the front wheels 138 and the rear wheels 142 may be steerable.

The front frame 118 of the grader 110 defines a first or front longitudinal axis 190, and the rear frame 122 of the grader 110 defines a second or rear longitudinal axis 194. An articulation joint 198 pivotally couples the front frame 118 and the rear frame 122 and defines a vertical pivot or articulation axis 196 (FIG. 2). The front frame 118 is pivotable relative to the rear frame 122 about the articulation axis 196 to vary an orientation of the front longitudinal axis 190 relative to the rear longitudinal axis 194. The illustrated articulation joint 198 is part of an active articulation assembly 192 that includes first and second articulation actuators 184, 188 extending between the front frame 118 and the rear frame 122 on opposite lateral sides of the articulation axis 196. Each of the illustrated articulation actuators 184, 188 is a double-acting hydraulic cylinder having a head 176 pivotally coupled to the rear frame 122 and a rod 180 pivotally coupled to the front frame 118. In other embodiments, the number and/or arrangement of articulation actuators 184, 188 may vary.

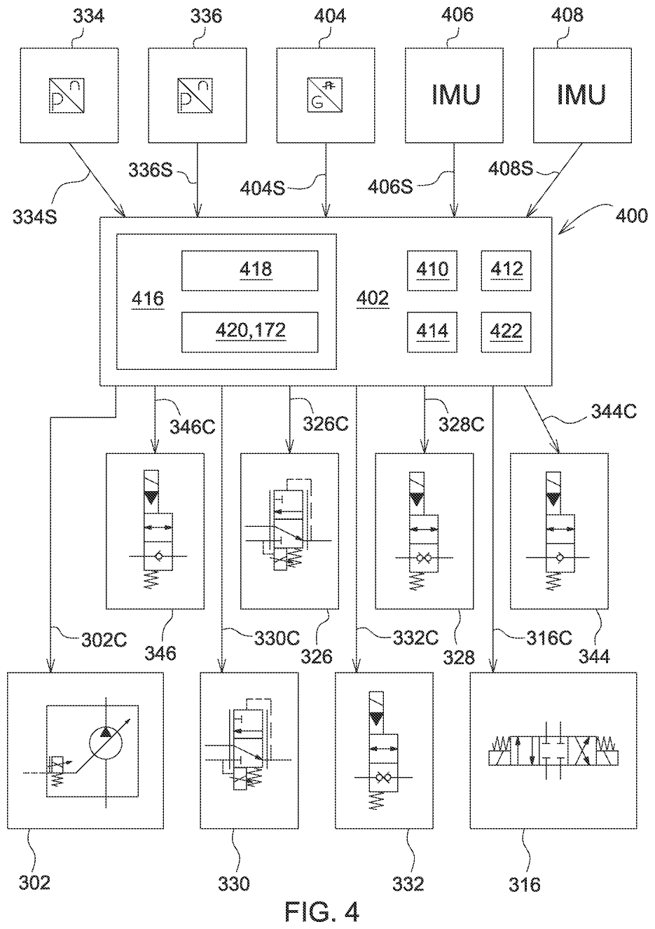

As shown in FIG. 1, a user interface 172 is positioned in the in the operator cab 126 to permit the user to operate the grader 110. In some embodiments, a user could operate the grader 110 from a location outside of the cab (i.e., by remote control). The illustrated grader 110 includes a controller 402 further described below with reference to FIG. 4. The controller 402 is configured to control operation of various components of the grader 110 in response to input from the user interface 172 and/or one or more controls remote from the grader 110.

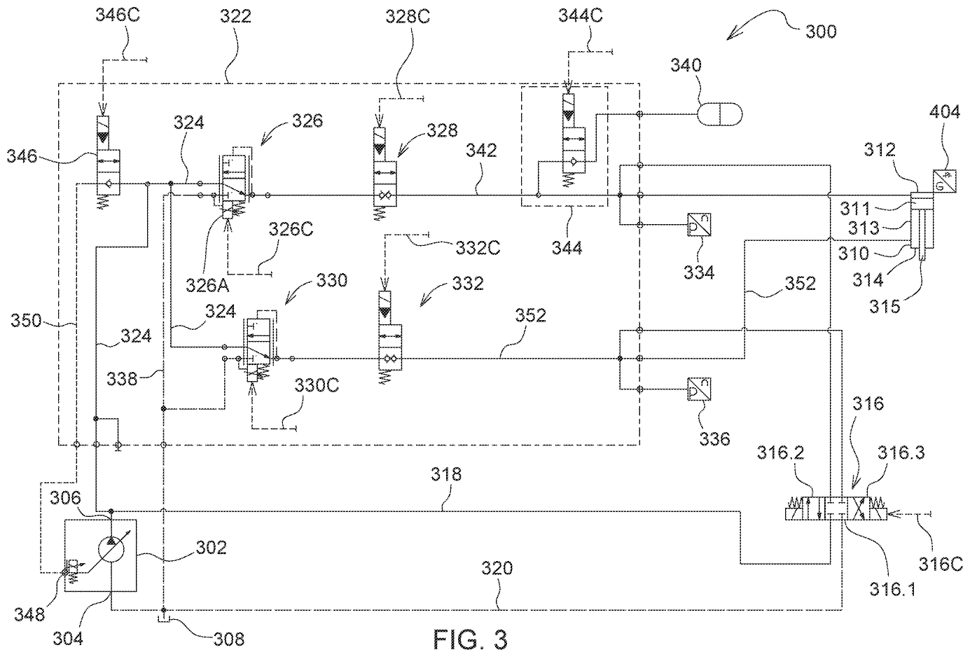

FIG. 3 illustrates a schematic hydraulic control circuit 300 according to some embodiments. The hydraulic control circuit 300 is operable to control movement of the work implement 158. The hydraulic control circuit 300 includes a pump 302, which in one embodiment may be a variable output pump 302 including a pump inlet 304 and a pump outlet 306. The pump inlet 304 draws hydraulic fluid from a reservoir or tank 308. The pump 302 will provide hydraulic fluid under pressure to an actuator 310 which is in fluid communication with the pump 302 and the reservoir 308 through the hydraulic control circuit 300. The actuator 310 may be representative of any of the hydraulic actuators of the work vehicle 110 described above with regard to FIGS. 1 and 2. The actuator 310 may include a piston 311 attached to a rod 315, with the piston 311 received within a cylinder 313.

The hydraulic actuator 310 includes a first side 312 and a second side 314. The first side 312 may also be referred to as a head side or head end 312, and the second side 314 may also be referred to as a rod side or rod end 314. A control valve 316 is fluidly positioned between the pump 302 and the hydraulic actuator 310 to control the flow of hydraulic fluid between the hydraulic actuator 310 and the pump 302 and the reservoir 308. Flow of hydraulic fluid to the head end 312 will push the piston of hydraulic cylinder 310 and the attached implement 158 down (when for example the actuator 310 represents lifting cylinders 166 and 168). Flow of hydraulic fluid to the rod end 314 will push the piston of hydraulic cylinder 310 up to lift the implement 158. A hydraulic fluid supply line 318 connects the pump outlet 306 with the control valve 316. A hydraulic fluid return line 320 connects the reservoir 308 with the control valve 316.

The control valve 316 may be a four port, three position electrohydraulic control valve as shown. In a middle position 316.1 flow through the supply and return lines 318 and 320 is blocked. In the left position 316.2 hydraulic fluid from pump 302 flows through supply line 318 to the head end 312 of actuator 310 to lower the implement 158, and hydraulic fluid from rod end 314 returns to reservoir 308 through return line 320. In the right position 316.3 hydraulic fluid hydraulic fluid from pump 302 flows through supply line 318 to the rod end 314 of actuator 310 to raise the implement 158, and hydraulic fluid from head end 312 returns to reservoir 308 through return line 320. The control valve 316 may operate in response to a command signal 316C from the controller 402.

The hydraulic circuit 300 also includes a variable float control system 322 generally indicated within the dashed box shown in FIG. 3. As is further explained below the variable float control system 322 allows the operator of the work vehicle 110 to selectively actuate the variable float control system 322 to add or subtract from the gravitational downward force acting on the implement 158 when the implement 158 is operating in a floating mode.

The pump 302 also provides hydraulic fluid under pressure to a pressure supply line 324. The pressure supply line 324 is communicated with the head end 312 of actuator 310 through a first proportional pressure reducing and/or relief valve (PPRV) 326 and a first electrohydraulic on/off valve 328. The pressure supply line 324 is communicated with the rod end 314 of actuator 310 through a second proportional pressure reducing and/or relief valve (PPRV) 330 and a second electrohydraulic on/off valve 332. The first and second PPRV's 326 and 330 are also communicated through a pressure return line 338 with the reservoir 308. The rod end 314 of actuator 310 is communicated with the second electrohydraulic on/off valve 332 and the second proportional pressure reducing and/or relief valve (PPRV) 330 via a line 352.

The pressure supply line 324 directly communicates the outlet 306 of pump 302 with each of the first and second PPRV's 326 and 330 without any intervening control valve between the pump 302 and the PPRV 326 or 330. This is contrasted to a system like that shown in U.S. Pat. No. 11,408,144 wherein a control valve is located between the pump and the PPRV's.

A first pressure sensor 334 is configured to sense a pressure at the first side 312 of the hydraulic actuator 310, the first pressure sensor 334 configured to generate a first pressure signal 334S. A second pressure sensor 336 is configured to sense a pressure at the second side 314 of the hydraulic actuator 310, the second pressure sensor 336 configured to generate a second pressure signal 336S.

As noted, each of the first and second PPRV's 326 and 330 may be a proportional pressure reducing and/or relief valve. As used herein, the term “proportional pressure reducing and/or relief valve” refers to a valve that has the capability to both reduce the fluid pressure provided from the pump 302 to the actuator 310 through the valve, and to relieve excess fluid pressure occurring at the actuator 310 and acting on the valve. The valve does not have to perform both functions at the same time, but it is capable of performing either function when needed.

As noted, an operator of the working vehicle 110 may selectively enable the variable float control system 322 by entering an appropriate command to the controller 402 which is further described below with regard to FIG. 4. The operator may also enter a set value for the pressure to be maintained by the PPRV's 326 and 330 on the head end 312 and rod end 314, respectively, of actuator 310. The pressures in the head end 312 and rod end 314 may be independently adjusted. The operator may input such commands via a user interface located in the operator cab 126 as further described below with regard to the controller 402.

The first PPRV 326 may operate as follows. The first PPRV 326 may be an inversely proportional PPRV, meaning that as the magnitude of an electric command signal 326C to the first PPRV 326 increases, the pressure provided from the first PPRV 326 to the head end 312 of actuator 310 decreases, and vice versa. The command signal 326C may be provided by controller 402 as further described below. The first PPRV 326 may be a spool type valve that is moved by a solenoid 326A between the two positions pictorially depicted in FIG. 3. Excess hydraulic fluid bleeds back to the reservoir 308 via pressure return line 338. Second PPRV 330 may operate in a substantially identical manner to control pressure in rod end 314.

When the operator enables the variable float control system 322 the electrohydraulic on/off valves 328 and 332 receive command signals 328C and 332C directing them to move to their open positions. When the operator disables the variable float control system 322 the command signals 328C and 332C direct the electrohydraulic on/off valves 328 and 332 to move to their closed positions. As pictorially depicted when in the closed positions flow in either direction through the electrohydraulic on/off valves 328 and 332 is blocked by a pair of internal check valves. The first and second electrohydraulic on/off valves 328 and 332 may be configured to directly receive the electrical command signals 328C and 332C from the controller 402, as contrasted to a system like that shown in U.S. Pat. No. 11,408,144 wherein the on/off valves are pilot operated and the electrical command signal goes to a separate control valve which controls flow of pilot hydraulic fluid to the on/off valves.

In some embodiments the variable float control system 322 may also include a hydraulic accumulator 340 connected to a pressure conduit 342 between the first PPRV 326 and the first side 312 of the actuator 310. An electrohydraulic on/off valve 344 may be placed between the pressure conduit 342 and the hydraulic accumulator 340 so as to enable or disable the hydraulic accumulator 340 in response to a command signal 344C from the controller 402. In other embodiments the hydraulic accumulator 340 may not be present.

In some embodiments the variable float control system 322 may also include an electrohydraulic recirculation valve 346 which allows hydraulic fluid from the pressure supply line 324 to recirculate to a second pump inlet 348 through recirculation line 350. The electrohydraulic recirculation valve 346 and recirculation line 350 allow the variable flow pump 302 to operate at maximum flow rate when the hydraulic control circuit 300 is initially turned on, so as to provide increased hydraulic pressure to the hydraulic control circuit 300. The electrohydraulic recirculation valve 346 may be operated in response to a command signal 346C from the controller 402. In some embodiments the electrohydraulic recirculation valve 346 and recirculation line 350 may not be present.

### The Control System

As schematically illustrated in FIG. 4, the work vehicle 110 may include a control system 400 including a controller 402. The controller 402 is configured to receive input signals from the various sensors, such as the pressure sensors 334 and 336. The signals transmitted from the various sensors to the controller 402 are schematically indicated in FIG. 4 by lines connecting the sensors to the controller with an arrowhead indicating the flow of the signal from the sensor to the controller 402.

In some embodiments the controller 402 may also receive a position signal 404S from a position sensor 404 associated with the actuator 310. The position sensor 404 may be configured to generate the position signal 404S representative of a position of the piston 311 relative to the cylinder 313 of the hydraulic actuator 310. In some embodiments hydraulic actuator 310 may be in the form of a hydraulic “smart cylinder” in which the position sensor 404 is integrated within the hydraulic actuator 310. In other embodiments the position sensor 404 may be external to the hydraulic actuator 310, for example in the form of a wire rope sensor having one end connected to the cylinder 313 and another end connected to the rod 315 attached to the piston 311.

In some embodiments the controller 402 may also receive one or more vehicle position signals such as 406S and 408S from position sensors 406 and 408 mounted on the work vehicle 110 (See FIG. 1). The position sensors 406 and 408 may for example be Inertial Measurement Units (IMU's) mounted on the front frame 118 and the drawbar 154.

Similarly, the controller 402 will generate control signals for controlling the operation of the various valves of the hydraulic control system 300 discussed above.

Controller 402 includes or may be associated with a processor 410, a computer readable medium 412, a data base 414 and an input/output module or control panel 416 having a display 418. An input/output device 420, such as a keyboard, joystick or other user interface, is provided so that the human operator may input instructions to the controller. It is understood that the controller 402 described herein may be a single controller having all of the described functionality, or it may include multiple controllers wherein the described functionality is distributed among the multiple controllers.

Various operations, steps or algorithms as described in connection with the controller 402 can be embodied directly in hardware, in a computer program product 422 such as a software module executed by the processor 410, or in a combination of the two. The computer program product 422 can reside in RAM memory, flash memory, ROM memory, EPROM memory, EEPROM memory, registers, hard disk, a removable disk, or any other form of computer-readable medium 412 known in the art. An exemplary computer-readable medium 412 can be coupled to the processor 410 such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

The control panel 416 may for example be physically located on the work vehicle 110, for example in the cab 126, such that the control panel 416 is supported directly or indirectly from the frame 118. Optionally, or additionally, the control panel 416 or some portion thereof may be remotely located, such as on a handheld device carried by a human operator. Further, in the event of an autonomous machine 110 the control panel 416 or some portion thereof may be located at a remote-control station and may be communicated with the controller 402 wirelessly. The input/output device 420 may include the user interface 172, or may be in addition to the user interface 172.

As is further described below with regard to various modes of operation the controller 402 is operably connected to the various control valves discussed above and with the variable pump 302, and sends command signals to each of those components. Each command signal is indicated in FIGS. 3 and 4 by the number of the component followed by the suffix “C”. For example, the pump 302 may receive a command signal 302C if the pump is a digital displacement pump.

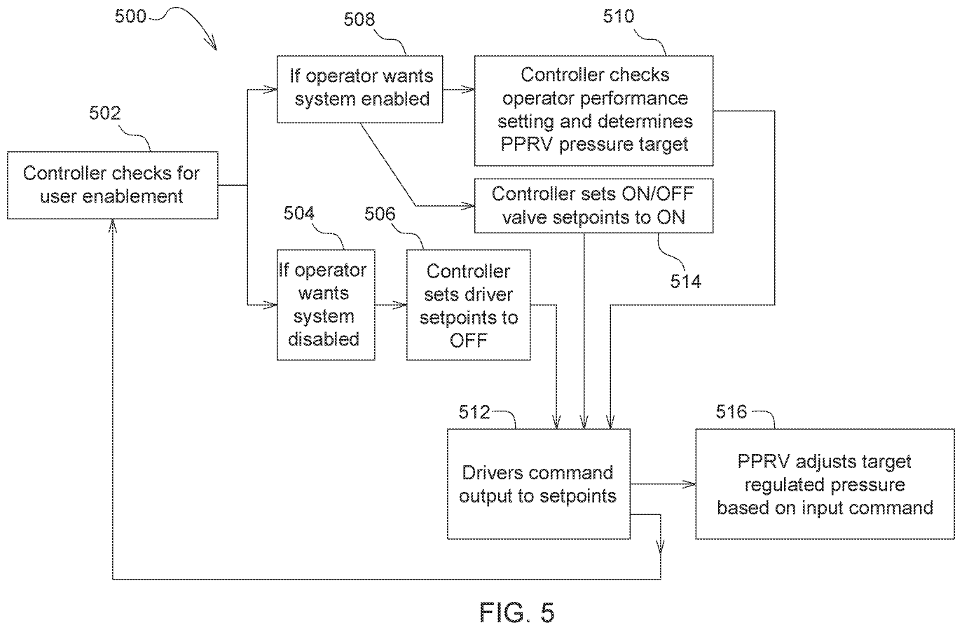

### Open Loop Control Embodiment—FIG. 5:

FIG. 5 provides a flow chart of the operating logic for the controller 402 when the controller 402 is configured to operate in an open loop control 500. In the open loop control the controller 402 does not utilize feedback from the pressure sensors 334 and 336, but instead merely sets the selected set points for the PPRV's 326 and 330 and allows the PPRV's to operate. In the open loop control 500 the operator first decides whether to enable the float control as indicated at block 502.

If the operator chooses to disable the float control as indicated at block 504, the controller 402 will turn off the variable float control system 322 as indicated at block 506 by moving the on/off valves 328 and 332 to their closed positions. The PPRV's are also closed at block 506. The operator input may be made via the input/output device 420. Then the operator may operate the work implement 158 by controlling the operation of the actuator 310 through the control valve 316.

If the operator chooses to enable the float control as indicated at block 508 the controller 402 checks at block 510 for other operator inputs determinative of a desired set point for the relief pressures of the PPRV's 326 and 330. For example, the operator may have selected between several available performance settings for the work vehicle 110, and the selected performance setting may have associated therewith a preferred set point for the force to be applied by the actuator 310 to the work implement 158. For example, the actuator 310 may be representative of the left and right lift actuators 166 and 168 which raise and lower the grader blade/work implement 158 on the motor grader 110. There will be a hydraulic control system 300 such as depicted in FIG. 3 associated with each of the left and right lift actuators 166 and 168.

Simultaneously with the setting of the set points for the PPRV's 326 and 330, the controller 402 will command the on/off valves 328 and 332 to their open positions, as indicated at block 514. Then as indicated at block 516 the grader blade 158 will be in an open loop control floating mode. If for example, the grader blade 158 encounters a large rock or other obstacle creating a sudden pressure increase in the head end 312 of the left and/or right lift actuators 166 and 168, the respective PPRV 326 associated with that head end 312 will relieve that excess pressure to the reservoir 308 via the return line 324.

In the context of the operation just described the first PPRV 326 may be described as a first proportional pressure reducing and/or relief valve (PPRV) 326 fluidly positioned between the reservoir 308 and the first side 312 of the hydraulic actuator 310, the first PPRV 326 being configured to permit flow of fluid from the first side 312 of actuator 310 to the reservoir 308 in response to a pressure at the first side 312 of the hydraulic actuator 310 being greater than a first predetermined pressure value. In this context, the first predetermined pressure value would be the value achieved by the set point of the first PPRV 326, regardless of whether that value was exactly equal to the desired value which the operator was attempting to achieve, or which the controller 402 selected based on the operator's selected performance setting.

Similarly, the second PPRV 330 may be described as being configured to permit flow of fluid from the second side 314 of the actuator 310 to the reservoir 308 in response to the pressure at the second side 314 of the hydraulic actuator 310 being greater than a second predetermined pressure value associated with the set point for the second PPRV 330.

It will be appreciated that in the open loop control mode, the setting of the set points for the PPRV's 326 and 330 is done by a single command signal from the controller 402 based on the operator input, such as the selected performance setting. The controller 402 will be configured to provide an appropriate command signal to the PPRV's which is determined to be correct for the desired downward force to be maintained on the grader blade 158. The command signal for a given set point may be determined from historical data, but there is no feedback or confirmation that the desired down force has been achieved. The selected set point may add force to the gravitational weight of the grader blade 158 by increasing the pressure in the head end 312 of the actuators, or it may reduce the effective gravitational weight of the grader blade 158 by increasing the pressure in the rod end 314. The set points for the PPRV's will be associated with a desired pressure value to be maintained at the head end 312 and/or rod end 314, but there is no feedback or confirmation that the exact desired pressure value has been achieved.

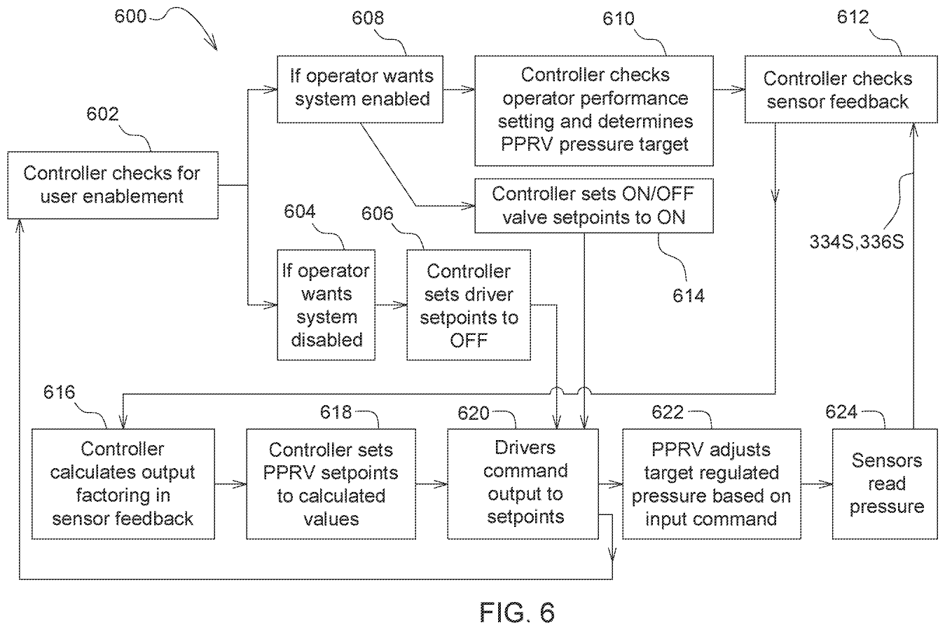

### Closed Loop Control Embodiment—FIG. 6:

FIG. 6 provides a flow chart of the operating logic for the controller 402 when the controller 402 is configured to operate in a closed loop control 600. In the closed loop control 600 the controller 402 uses feedback from the pressure sensors 334 and 336 to continuously adjust the set points of the PPRV's 326 and 330 if and as needed to achieve a desired pressure in the head ends 312 and rod ends 314 and corresponding down force on the grader blade 158.

In the closed loop control mode 600 the operator first decides whether to enable the float control as indicated at block 602. If the operator chooses to disable the float control as indicated at block 604, the controller 402 will turn off the variable float control system 322 as indicated at block 606 by moving the on/off valves 328 and 332 and the PPRV's to their closed positions. The operator input may be made via the input/output device 420. Then the operator may operate the work implement 158 by controlling the operation of the actuator 310 through the control valve 316.

If the operator chooses to enable the float control as indicated at block 608 the controller 402 checks at block 610 for other operator inputs determinative of a desired set point for the relief pressures of the PPRV's 326 and 330. For example, the operator may have selected between several available performance settings for the work vehicle 110, and the selected performance setting may have associated therewith a preferred set point for the force to be applied by the actuator 310 to the work implement 158. For example, the actuator 310 may be representative of the left and right lift actuators 166 and 168 which raise and lower the grader blade/work implement 158 on the motor grader 110. There will be a hydraulic control system 300 such as depicted in FIG. 3 associated with each of the left and right lift actuators 166 and 168.

Simultaneously with the setting of the set points for the PPRV's 326 and 330, the controller 402 will command the on/off valves 328 and 332 to their open positions, as indicated at block 614.

After receiving the base setting of the set point or set value for the PPRV's at block 610, the controller 402 checks at block 612 for input signals 334S and/or 336S from the pressure sensors 334 and 336 associated with the head end 312 and rod end 314, respectively, of the associated hydraulic actuator 310. Then as indicated at block 616 the controller 402 calculates an adjusted command signal 326C and/or 330C to the PPRV's to achieve the desired pressure value at the actuator 310. For example, if the desired floating pressure in the head end 312 of the hydraulic actuator 310 is 1000 psi the controller 402 may determine an appropriate command signal 326C and/or 330C based on preprogrammed information as it does in block 510 of the open loop control mode, but now in block 616 the controller 402 can determine whether it needs to adjust that command signal up or down to achieve the desired downward force at head end 312. At block 618 the controller 402 sends the adjusted command signal 326C and/or 330C to the PPRV's based on the sensor feedback from the pressure sensors 334 and 336. At block 620 the PPRV's 326 and/or 330 make the commanded adjustment in setting. As a result of the feedback from the pressure sensors 334 and 336 the controller directs adjustment of the PPRV's such that the actual pressure achieved at the head end 312 and rod end 314 is closer to the set value that it was before the adjustment.

Then as indicated at block 622 the PPRV's 326 and 330 control the pressure applied to the actuator 310 so that the grader blade 158 “floats” with the desired down force. If the grader blade 158 encounters a large rock or other obstacle creating a sudden pressure increase in the head end 312 of the left and/or right lift actuators 166 and 168, the respective PPRV 326 associated with that head end 312 will relieve that excess pressure to the reservoir 308 via the return line 324. As indicated at block 624, the pressure sensors 334 and 336 continuously monitor the actual pressure in head end 312 and rod end 314 and feed that information back to controller 402 as signals 334S and 336S.

In the context of the closed loop control mode 600, the controller 402 may be described as being in electrical communication with the control valve 316, the first and second PPRV's 326 and 330, and the first and second pressure sensors 334 and 336, the controller 402 being configured to receive a set value for the first predetermined pressure value (such as through the operator's performance setting), and to receive the first pressure signal 334S from the first pressure sensor 334, the controller 402 being configured to send a command signal 326C to the first PPRV 326 to adjust the first predetermined pressure value based at least in part on the set value for the first predetermined pressure value and based at least in part on the first pressure signal 334S.

### The Accumulator

As previously noted, the hydraulic control circuit 300 may include the hydraulic accumulator 340. The hydraulic accumulator 340 may serve two purposes. First, accumulator 340 may function as a hydraulic spring to cushion the effect of physical impacts on the grader blade 158 and to cushion the corresponding spikes in hydraulic pressure in the hydraulic control circuit 300. Second, in an event where the grader blade 158 is initially held above the ground surface and then released to drop to the ground surface, the accumulator 340 can provide an immediate source of hydraulic fluid to prevent or reduce cavitation in the head end 312 of the actuator 310.

### The Recirculation Valve

As also previously noted, the hydraulic control circuit may include the electrohydraulic recirculation valve 346. The electrohydraulic recirculation valve 346 allows hydraulic fluid from the pressure supply line 324 to recirculate to the second pump inlet 348 through recirculation line 350. The electrohydraulic recirculation valve 346 and recirculation line 350 allow the variable flow pump 302 to operate at maximum flow rate when the hydraulic control circuit 300 is initially turned on, so as to provide increased hydraulic pressure to the hydraulic control circuit 300. The electrohydraulic recirculation valve 346 may be operated in response to a command signal 346C from the controller 402. The use of the electrohydraulic recirculation valve 346 to increase available system operating pressures on start-up is a further means of avoiding or reducing cavitation in the actuator 310 in situations where the hydraulic control circuit 300 would otherwise be unable to initially keep up with the gravitational forces acting on the work implement 158.

More generally, the controller 402 may be configured to direct the electrohydraulic recirculation valve 346 to open and the variable output pump 302 to increase its output in response to a detected need for increased hydraulic pressure in the hydraulic control circuit.

### Blade Position Sensing

As noted, the actuator 310 may be provided with the actuator position sensor 404. Also, the control system 400 may include the vehicle position sensors 406 and 408 which may be described as vehicle orientation sensors 406 and 408 configured to detect an orientation of the work vehicle 110 within a reference system external to the work vehicle and to generate corresponding vehicle orientation signals 406S and 408S.

The controller 402 may be further configured to receive the actuator position signal 404S and the vehicle orientation signals 406S and 408S, and to control a speed of extension or retraction of the hydraulic actuator 310 at least in part in response to the actuator position signal 404S and the vehicle orientation signals 406S and 408S. For example, in a situation where the grader blade 158 is raised high above the ground surface by retraction of the lifting actuators 166 and 168, the controller 402 may determine the height of the grader blade 158 above the ground. Then as the lifting actuators 166 and 168 extend to lower the grader blade 158, the controller may track the height of the grader blade 158 above the ground. The normal rate of extension of the lifting actuators 166 and 168 may be such that an excessively long time is required to lower the grader blade to the ground. The controller 402 may command the lifting actuators 166 and 168 and the PPRV's 326 and 330 to lower the grader blade 158 more quickly so long as the grader blade 158 is a safe distance above the ground, and then slow the rate of descent as the grader blade 158 approaches the ground surface. This configuration would be intended to allow the grader blade 158 to be lowered at a rate similar to that which the operator is accustomed to experiencing in conventional work machines without the adjustable float control system 322 of the present disclosure. When the grader blade 158 reaches or is near the ground surface, the PPRV's 326 and 330 will have their relief pressure settingd adjusted to match the downforce setting selected by the operator with the operator's selection of a performance setting for the work vehicle 110.

Thus, it is seen that the apparatus and methods of the embodiments disclosed herein readily achieve the ends and advantages mentioned as well as those inherent therein. While certain preferred embodiments have been illustrated and described for purposes of the present disclosure, numerous changes in the arrangement and construction of parts and steps may be made by those skilled in the art, which changes are encompassed within the scope and spirit of the present invention as defined by the appended claims.

What is claimed is:

1. A work vehicle comprising:
a frame;
an operator cab connected to the frame;
a work implement movable relative to the frame; and
a hydraulic control circuit operable to control movement of the work implement, the hydraulic control circuit including:
a pump;
a reservoir;
a hydraulic actuator including a first side and a second side, the hydraulic actuator being configured to move the work implement relative to the frame;
a control valve configured to control supply of hydraulic fluid from the pump to the actuator, and return of hydraulic fluid from the actuator to the reservoir;
a first proportional pressure reducing and/or relief valve (PPRV) fluidly positioned between the reservoir and the first side of the hydraulic actuator, the first PPRV configured to permit flow of fluid from the first side of actuator to the reservoir in response to a pressure at the first side of the hydraulic actuator being greater than a first predetermined pressure value;
a second PPRV fluidly positioned between the reservoir and the second side of the hydraulic actuator;
a first pressure sensor configured to sense a pressure at the first side of the hydraulic actuator, the first pressure sensor configured to generate a first pressure signal; and
a second pressure sensor configured to sense a pressure at the second side of the hydraulic actuator, the second pressure sensor configured to generate a second pressure signal; and
a controller in electrical communication with the control valve, the first and second PPRV's, and the first and second pressure sensors, the controller being configured to receive a set value for the first predetermined pressure value, and to receive the first pressure signal from the first pressure sensor, the controller being configured to send a command signal to the first PPRV to adjust the first predetermined pressure value based at least in part on the set value for the first predetermined pressure value and based at least in part on the first pressure signal.

2. The work vehicle of claim 1, wherein:
the controller is configured such that the command signal directs adjustment of the first PPRV such that the first predetermined pressure value is closer to the set value than it was before the adjustment.

3. The work vehicle of claim 1, wherein:
the first PPRV is directly communicated with the pump without any intervening control valve between the pump and the first PPRV.

4. The work vehicle of claim 3, wherein:
the second PPRV is directly communicated with the pump without any intervening control valve between the pump and the second PPRV.

5. The work vehicle of claim 1, wherein:
the second PPRV is configured to permit flow of fluid from the second side of the actuator to the reservoir in response to the pressure at the second side of the hydraulic actuator being greater than a second predetermined pressure value.

6. The work vehicle of claim 5, wherein the first predetermined pressure value is adjustable independently of the second predetermined pressure value.

7. The work vehicle of claim 1, wherein:
the first PPRV is a first electrohydraulic inversely proportional PPRV; and
the second PPRV is a second electrohydraulic inversely proportional PPRV.

8. The work vehicle of claim 7, wherein the hydraulic control circuit further includes:
a first electrohydraulic on/off valve located between the first electrohydraulic inversely proportional PPRV and the first side of the hydraulic actuator;
a second electrohydraulic on/off valve located between the second electrohydraulic inversely proportional PPRV and the second side of the hydraulic actuator; and
wherein the first and second electrohydraulic on/off valves are configured to directly receive first and second electrical control signals, respectively.

9. The work vehicle of claim 8, wherein:
the first and second PPRV's are directly communicated with the pump without any intervening control valve between the pump and the first and second PPRV's.

10. The work vehicle of claim 1, wherein the operator cab includes a user interface configured to permit a user to adjust the first predetermined pressure value while the user is positioned in the operator cab.

11. The work vehicle of claim 1, further comprising:
a hydraulic accumulator connected to a pressure conduit between the first PPRV and the first side of the hydraulic actuator.

12. The work vehicle of claim 1, wherein:
the pump is a variable output pump including a pump inlet and a pump outlet;
the hydraulic control circuit further includes a recirculation line communicating the pump outlet with the pump inlet, and an electrohydraulic recirculation valve disposed in the recirculation line; and
the controller is configured to direct the electrohydraulic recirculation valve to open and the variable output pump to increase its output in response to a detected need for increased hydraulic pressure in the hydraulic control circuit.

13. The work vehicle of claim 1, wherein:
the hydraulic control circuit further includes a position sensor configured to detect a position of the hydraulic actuator and to generate a corresponding actuator position signal;
the work vehicle further includes a vehicle orientation sensor configured to detect an orientation of the work vehicle within a reference system external to the work vehicle and to generate a corresponding vehicle orientation signal; and
the controller is configured to receive the actuator position signal and the vehicle orientation signal, and to control a speed of extension or retraction of the hydraulic actuator at least in part in response to the actuator position signal and the vehicle orientation signal.

14. A work vehicle comprising:
a frame;
a work implement movable relative to the frame; and
a hydraulic control circuit operable to control movement of the work implement, the hydraulic control circuit including:
a pump;
a reservoir;
a hydraulic actuator including a first side and a second side, the hydraulic actuator being configured to move the work implement relative to the frame;
a control valve configured to control supply of hydraulic fluid from the pump to the actuator, and return of hydraulic fluid from the actuator to the reservoir;
a controller in electrical communication with the control valve;
a first proportional pressure reducing and/or relief valve (PPRV) fluidly positioned between the reservoir and the first side of the hydraulic actuator, the first PPRV configured to permit flow of fluid from the first side of actuator to the reservoir in response to a pressure at the first side of the hydraulic actuator being greater than a first predetermined pressure value, the first PPRV being directly communicated with the pump without any intervening control valve between the pump and the first PPRV; and
a second PPRV fluidly positioned between the reservoir and the second side of the hydraulic actuator.

15. The work vehicle of claim 14, wherein:
the second PPRV is directly communicated with the pump without any intervening control valve between the pump and the second PPRV.

16. The work vehicle of claim 15, wherein:
the first PPRV is a first electrohydraulic inversely proportional PPRV; and
the second PPRV is a second electrohydraulic inversely proportional PPRV.

17. The work vehicle of claim 16, wherein the hydraulic control circuit further includes:
a first electrohydraulic on/off valve located between the first electrohydraulic inversely proportional PPRV and the first side of the hydraulic actuator;
a second electrohydraulic on/off valve located between the second electrohydraulic inversely proportional PPRV and the second side of the hydraulic actuator; and
wherein the first and second electrohydraulic on/off valves are configured to directly receive first and second electrical control signals, respectively.

18. The work vehicle of claim 14, further comprising:
a hydraulic accumulator connected to a pressure conduit between the first PPRV and the first side of the hydraulic actuator.

19. The work vehicle of claim 14, wherein:
the pump is a variable output pump including a pump inlet and a pump outlet;
the hydraulic control circuit further includes a hydraulic feedback conduit communicating the pump outlet with the pump inlet, and an electrohydraulic on/off feedback valve disposed in the hydraulic feedback conduit; and
the controller is configured to direct the electrohydraulic on/off feedback valve to open and the variable output pump to increase its output in response to a detected need for increased hydraulic pressure in the hydraulic control circuit.

20. The work vehicle of claim 14, wherein:
the hydraulic control circuit further includes a position sensor configured to detect a position of the hydraulic actuator and to generate a corresponding actuator position signal;
a vehicle orientation sensor configured to detect an orientation of the work vehicle within a reference system external to the work vehicle and to generate a corresponding vehicle orientation signal; and
the controller is configured to receive the actuator position signal and the vehicle orientation signal, and to control a speed of extension or retraction of the hydraulic actuator at least in part in response to the actuator position signal and the vehicle orientation signal.
